(19) United States
(12) Patent Application Publication
(10) Pub. No.: US 2015/0380710 A1
(43) Pub. Date: Dec. 31, 2015

(54) BATTERY HOLDING DEVICES AND BATTERY PACKAGES

(71) Applicant: TENERGY CORPORATION, Fremont, CA (US)

(72) Inventors: Matthew MORLEY, Santa Clara, CA (US); Benjamin MULL, San Jose, CA (US)

(73) Assignee: TENERGY CORPORATION

(21) Appl. No.: 14/733,688

(22) Filed: Jun. 8, 2015

Related U.S. Application Data
(60) Provisional application No. 62/017,109, filed on Jun. 25, 2014.

(51) Int. Cl. H01M 2/20

(52) U.S. Cl. CPC H01M 2/204; H01M 2/206

(57) ABSTRACT

Battery holding devices, interconnect devices, and battery packages are disclosed. One such battery holding device may include a receiving portion for receive electrical terminals of a battery. The receiving portion may include front and back faces. The front face may include at least one front opening for exposing at least one of the electrical terminals. The back face may include at least one back opening for exposing at least one of the electrical terminals. One such battery package may include one or more batteries residing in one or more holding devices with one or more interconnect devices interlaced between adjacent holding devices.

### CROSS REFERENCE TO RELATED APPLICATION

The present application claims the benefit of priority to U.S. Provisional Application No. 62/017,109, filed Jun. 25, 2014, the entire content of which is incorporated herein by reference.

### TECHNICAL FIELD

The present disclosure relates to battery packages. More particularly, the present disclosure relates to battery packages having prismatic cells or pouch cells.

### BACKGROUND

Prismatic cell batteries are widely used in electronic devices. They are usually wrapped in packages resembling a small box, making optimal use of space by using a layered approach. To achieve high voltage and/or high current output, multiple cells need to be assembled together. It is difficult, however, to pack multiple cells into a battery package and at the same time, achieve the required connection requirements. Therefore, it is desirable to develop a holding device that is both easy to assemble multiple cells into different battery configurations and rigid enough to withstand cell swelling.

### SUMMARY

The present application provides battery holding devices, interconnect devices, and battery packages.

Some disclosed embodiments may involve a device for holding a battery. The device may comprise a receiving portion for receiving electrical terminals of the battery. The receiving portion may include a front face and a back face. The front face may include at least one front opening for exposing at least one of the electrical terminals. The back face may include at least one back opening for exposing at least one of the electrical terminals.

The present application also provides a battery package. The battery package may comprise a plurality of batteries and a plurality of holding devices for holding the plurality of batteries. Each of the plurality of holding devices may comprise a receiving portion for receiving electrical terminals of one of the plurality of batteries. The receiving portion may include a front face and a back face. The front face may include at least one front opening for exposing one of the electrical terminals of the one of the plurality of batteries. The back face may include at least one back opening for exposing one of the electrical terminals of the one of the plurality of batteries.

Some disclosed embodiments may involve a device for holding a battery. The device may comprise a receiving portion for receiving electrical terminals of the battery. The receiving portion may include first and second edges extending along first and second sides of the receiving portion, respectively. The receiving portion may also include a third edge extending from the first side to the second side of the receiving portion. The first and third edges may form a first channel and the second and third edges may form a second channel. The first and second channels may be electrically isolated from each other.

The preceding summary is not intended to restrict in any way the scope of the claimed invention. In addition, it is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate various embodiments and exemplary aspects of the present invention and, together with the description, explain principles of the invention. In the drawings:

FIG. 1 is a schematic diagram of an exemplary battery package, in accordance with some disclosed embodiments;

FIG. 2A is a schematic diagram of an exemplary battery package with a parallel connection configuration, in accordance with some disclosed embodiments;

FIG. 2B is a schematic diagram of an exemplary battery package with a serial connection configuration, in accordance with some disclosed embodiments;

FIG. 3 is a schematic diagram of an exemplary battery holding device, in accordance with some disclosed embodiments;

FIG. 4 is a plane view of the exemplary battery holding device shown in FIG. 3, in accordance with some disclosed embodiments;

FIG. 5 is a schematic diagram of an exemplary bottom portion of a battery holding device, in accordance with some disclosed embodiments;

FIGS. 6A and 6B show an exemplary interconnect device for a serial connection configuration, in accordance with some disclosed embodiments;

FIGS. 6C and 6D show plane views of the exemplary interconnect device shown in FIGS. 6A and 6B, in accordance with some disclosed embodiments;

FIGS. 7A and 7B show another exemplary interconnect device for a serial connection configuration, in accordance with some disclosed embodiments;

FIGS. 7C and 7D show plane views of the exemplary interconnect device shown in FIGS. 7A and 7B, in accordance with some disclosed embodiments;

FIGS. 8A and 8B show an exemplary interconnect device for a parallel connection configuration, in accordance with some disclosed embodiments;

FIGS. 9A and 9B show plane views of the exemplary interconnect device shown in FIGS. 8A and 8B, in accordance with some disclosed embodiments;

FIG. 10A is an exemplary battery package configuration using a serial connection, in accordance with some disclosed embodiments;

FIG. 10B is a schematic diagram illustrating the serial connection configuration shown in FIG. 10A, in accordance with some disclosed embodiments;

FIG. 10C is another exemplary battery package configuration using a serial connection, in accordance with some disclosed embodiments;

FIG. 10D is a schematic diagram illustrating the serial connection configuration shown in FIG. 10C, in accordance with some disclosed embodiments;

FIG. 11A is an exemplary battery package configuration using a parallel connection, in accordance with some disclosed embodiments;

FIG. 11B is a schematic diagram illustrating the parallel connection configuration shown in FIG. 11A, in accordance with some disclosed embodiments;

FIG. 12 is a schematic diagram of an exemplary battery package having an exemplary foolproof structure, in accordance with some disclosed embodiments;

FIG. 13A is a schematic diagram of an exemplary battery package having a single battery cell, in accordance with some disclosed embodiments;

FIG. 13B is a schematic diagram of an exemplary battery package having multiple battery cells, in accordance with some disclosed embodiments;

FIG. 13C shows the top view of the multi-cell battery package of FIG. 13B;

FIG. 13D shows the top view of the multi-cell battery package of FIG. 13B in a serial connection;

FIG. 13E shows the top view of the multi-cell battery package of FIG. 13B in a parallel connection; and

FIG. 13F shows the top view of the multi-cell battery package of FIG. 13B in a serial-parallel connection.

### DETAILED DESCRIPTION OF THE EMBODIMENTS

Reference will now be made in detail to exemplary embodiments of the invention, examples of which are illustrated in the accompanying drawings. When appropriate, the same reference numbers are used throughout the drawings to refer to the same or like parts.

Embodiments of the present disclosure involve apparatuses and devices for holding batteries. As used herein, batteries may include any device comprising one or more electrochemical cells that convert stored chemical energy into electrical energy, such as zinc-carbon batteries, alkaline batteries, lead-acid batteries, nickel-cadmium batteries, nickel-zinc batteries, nickel metal hydride batteries, lithium-ion batteries, lithium iron phosphate batteries, etc. The batteries may be used in electronics, computers, medical devices, power tools, cars, storage devices, etc. The batteries may form a battery pack, including multiple battery cells connected in series, in parallel, or having both series and parallel configurations. In this disclosure, the term cell refers to any single device containing electrodes immersed in an electrolyte used for current generation. A cell may include prismatic, pouch, or cylindrical compositions. The term battery refers to one or more cells connected together. Cells may be connected either mechanically and/or electrically (e.g., in series, parallel, or combination thereof). A battery may include a battery pack including multiple cells or a single battery cell. In some embodiments, batteries may include pouch cells or prismatic cells that may be lithium-ion based and/or lithium-polymer based. In some embodiments, a prismatic or pouch cell may have a voltage rating of 3.6 V. In other embodiments, a prismatic or pouch cell may have different voltage ratings depending on particular chemistry and manufacturing applications. In some embodiments, a prismatic or pouch cell may have a thickness of about 15 mm. In other embodiments, prismatic or pouch cells may have other dimensions depending on particular applications.

Holding a cell or battery may include fixing, stabilizing, assembling, or placing the cell or battery into or onto a structure such that the cell or battery may be held in place for purposes of, for example, packaging, interconnecting, or utilizing in any suitable ways. A cell or battery holding device or apparatus may include any rack, stack, frame, enclosure, box, assembly, or any other structures that at least partially hold the cell or battery. A cell or battery package may include one or more batteries or battery cells that are packed together. In some embodiments, a battery package may include one or more cell or battery holding devices to assemble the batteries together.

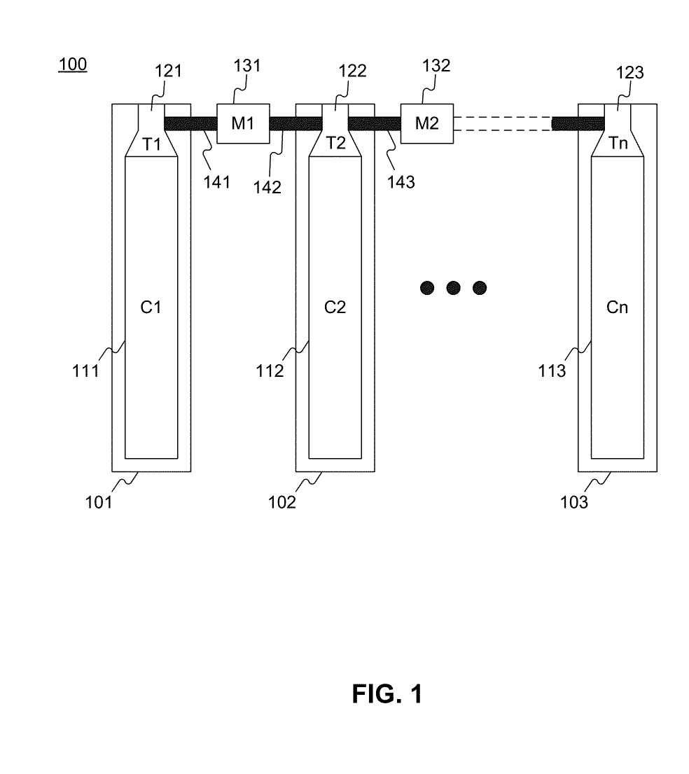

FIG. 1 is a schematic diagram of an exemplary battery package, in accordance with some disclosed embodiments. As shown in FIG. 1, battery package 100 may include a plurality of battery cells C1 (reference number 111), C2 (reference number 112), . . . Cn (reference number 113). Each battery cell may include one or more electrical terminals, such as T1 (reference number 121), T2 (reference number 122), . . . Tn (reference number 123). A battery cell may include a positive electrical terminal (e.g., usually denoted by “+”) and a negative electrical terminal (e.g., usually denoted by “−”). In FIG. 1, each battery cell (C1, C2, . . . , Cn) may be held by a respective battery holding device (101, 102, . . . 103). Battery holding devices 101, 102, . . . , 103 may hold their respective battery cell in place for purposes of, for example, interconnecting the battery cells.

Referring to FIG. 1, battery package 100 may include one or more interconnect devices M1 (reference number 131), M2 (reference number 132), etc., for connecting different battery cells (e.g., C1, C2, . . . , Cn). For example, battery cells C1, C2, . . . , Cn may be connected in serial, in parallel, or the combination thereof. Connectors 141, 142, 143, etc., may be used to establish electrical connections between different terminals of different battery cells. It is noted that connectors 141, 142, 143, etc. may include separate connectors such as wires or tape shape connectors. Alternatively, connectors 141, 142, 143, etc. may represent a logical electrical connection between electrical terminal (such as T1, T2, . . . , Tn) and interconnect devices M1, M2, etc., but may not include separate connectors. For example, M1 and T1 may be connected together by spot welding, laser welding, riveting, clamping or other suitable methods. In such case, a separate connector between T1 and M1 may not be needed.

In some embodiments, connectors 141, 142, 143, etc. may include a conductive bus bar, a metal sheet, a PCBA, a flex PCB, etc. When PCB is used as connector, terminals T1, T2, . . . Tn, etc. may be connected to substrate, ports, connecting points, etc., of the PCB. The PCB connector may also include integrated circuits, microchips, controllers, etc., to control, monitor, and/or regulate the battery cells. Connectors 141, 142, 143, etc. may be fixed to terminals T1, T2, . . . Tn and/or interconnect devices M1, M2, etc. by welding, screws, snap fit, or magnets to the cells.

In some embodiments, interconnect devices (e.g., 131, 132, etc.) may be used to connect to connectors 141, 142, 143, etc. to achieve desired interconnection configurations. For example, M1 may be designed to connect connectors 141 and 142 such that C1 and C2 are connected in serial. In another example, M1 may be designed to connect connectors 141 and 142 such that C1 and C2 are connected in parallel. FIG. 1 shows that connectors 141, 142, and 143, interconnect devices M1 and M2 all have a width. This is just for purpose of illustration. In practice, connectors 141, 142, and 143 may be thin sheets of connecting materials; interconnect devices M1 and M2 may be a thin plastic device; and the battery cells C1 and C2 may be closely arranged.

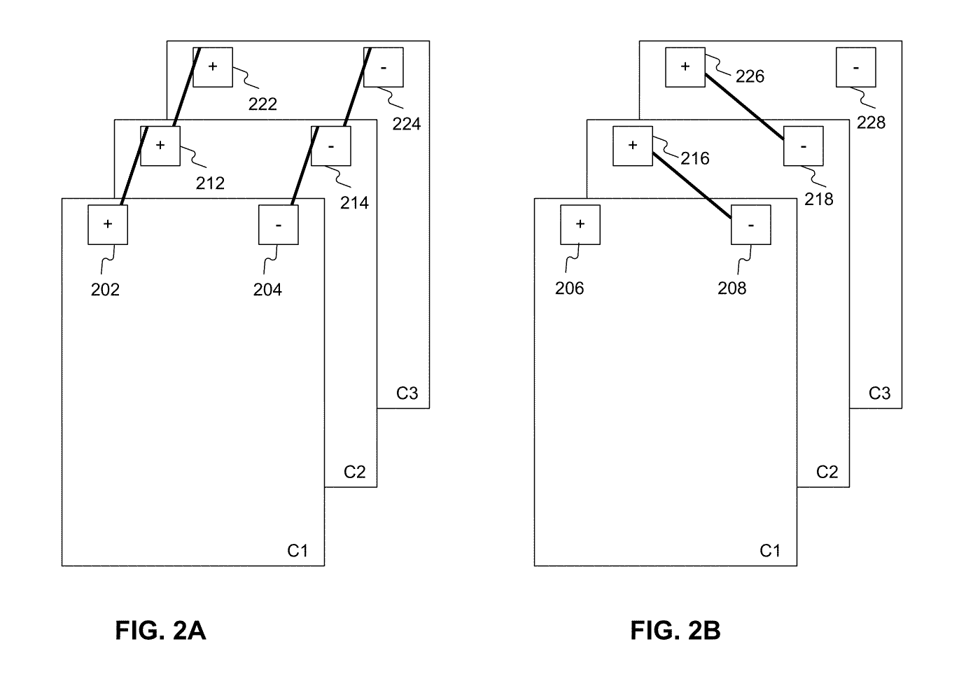

FIG. 2A is a schematic diagram of an exemplary battery package with a parallel connection configuration, in accordance with some disclosed embodiments. In FIG. 2A, battery cell C1 has a positive terminal 202 and a negative terminal 204. Similarly, battery cell C2 has a positive terminal 212 and a negative terminal 214; battery cell C3 has a positive terminal 222 and a negative terminal 224. In the parallel connection configuration, positive terminals 202, 212, and 222 are connected together, while negative terminals 204, 214, and 224 are connected together. The resulting battery pack consisting of battery cells C1-C3 has a common positive terminal (202/212/222) and a common negative terminal (204/214/224). It is noted that although three battery cells are shown in FIG. 2A, few (e.g., two cells) or more cells can be similarly connected together in parallel.

FIG. 2B is a schematic diagram of an exemplary battery package with a serial connection configuration, in accordance with some disclosed embodiments. In FIG. 2B, battery cell C1 has a positive terminal 206 and a negative terminal 208. Similarly, battery cell C2 has a positive terminal 216 and a negative terminal 218; battery cell C3 has a positive terminal 226 and a negative terminal 228. In the serial connection configuration, negative terminal 208 of battery cell C1 connects to positive terminal 216 of battery cell C2; negative terminal 218 of battery cell C2 connects to positive terminal 226 of battery cell C3. The resulting battery pack consisting of battery cells C1-C3 has a positive terminal 206 and a negative terminal 228. It is noted that although three battery cells are shown in FIG. 2B, few (e.g., two cells) or more cells can be similarly connected together in serial.

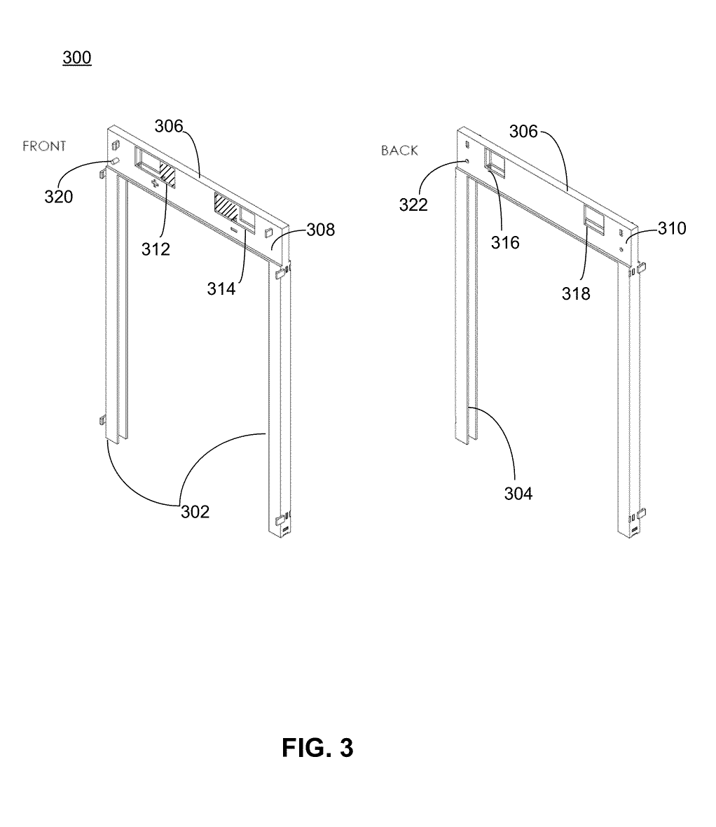

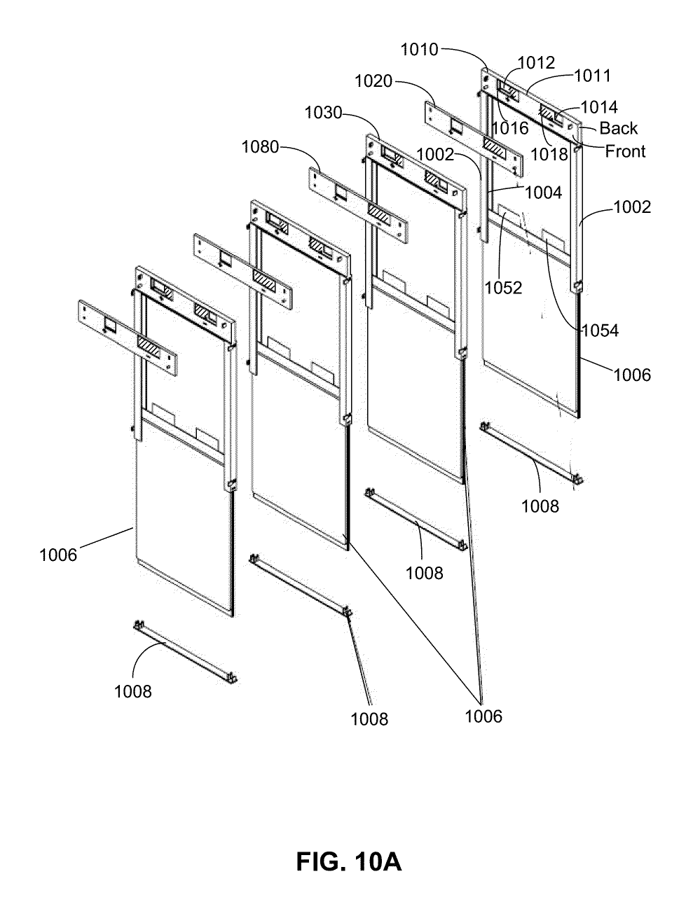

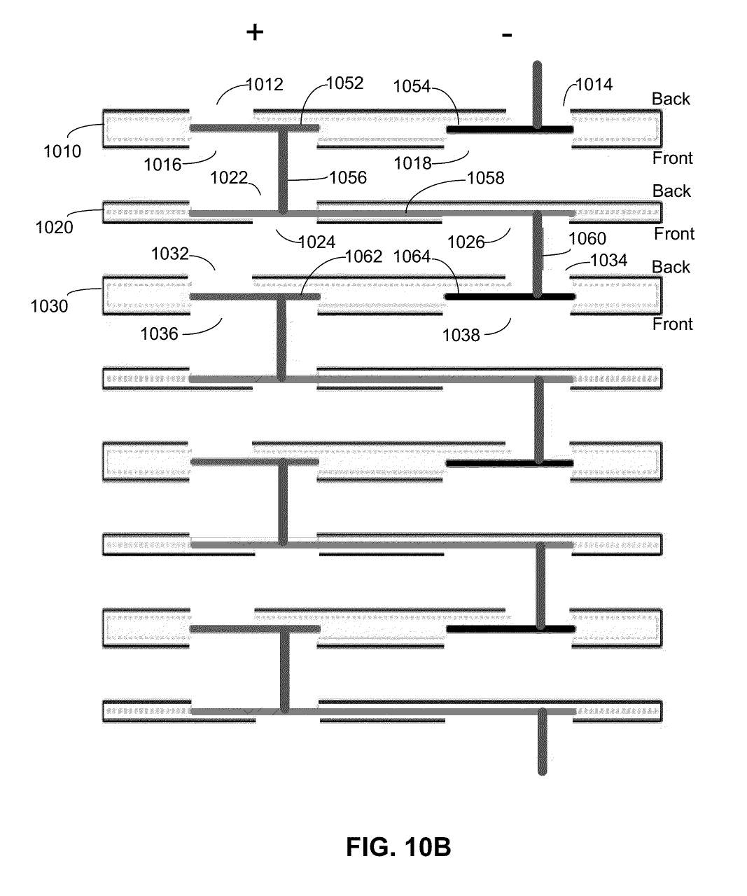

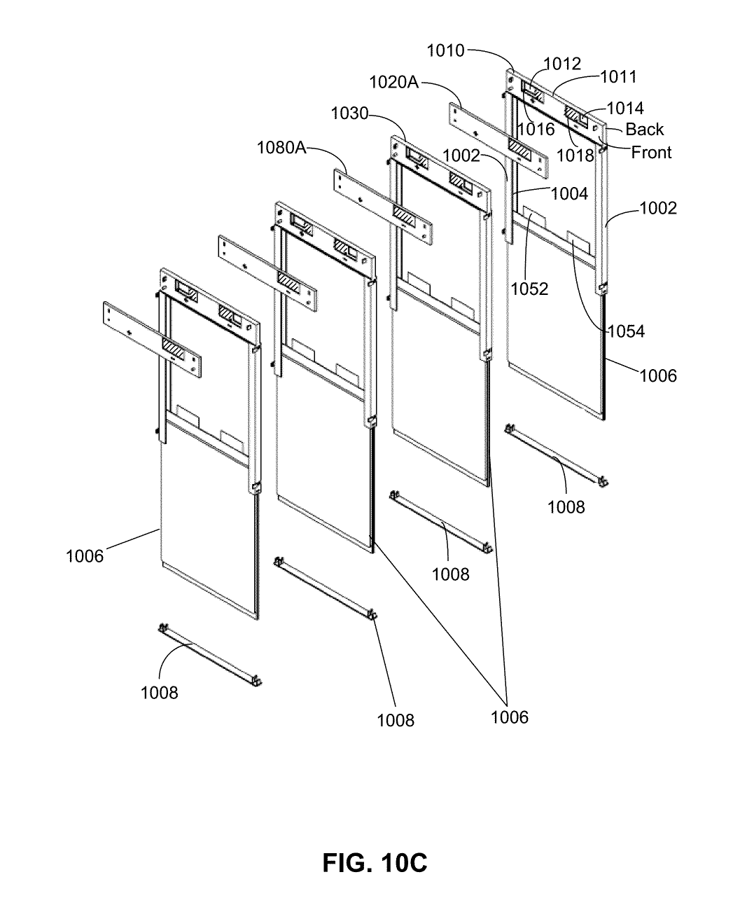

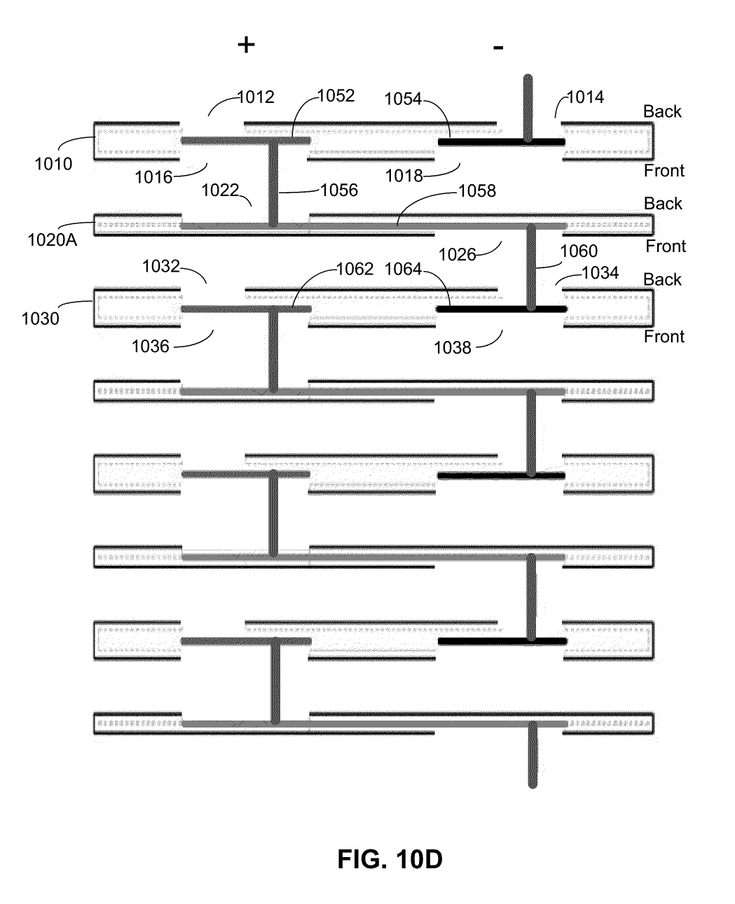

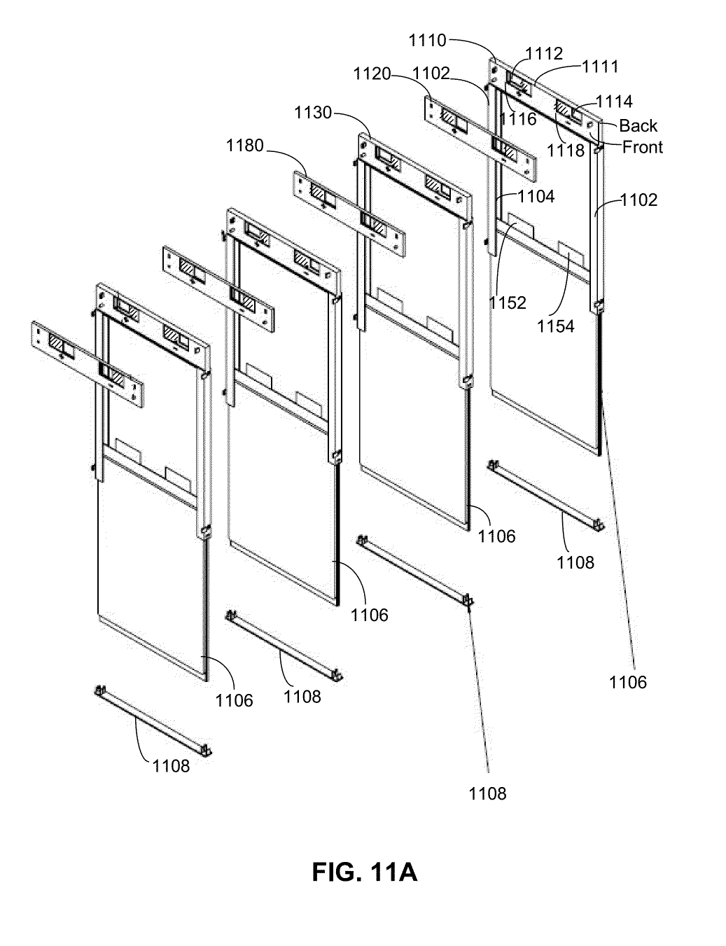

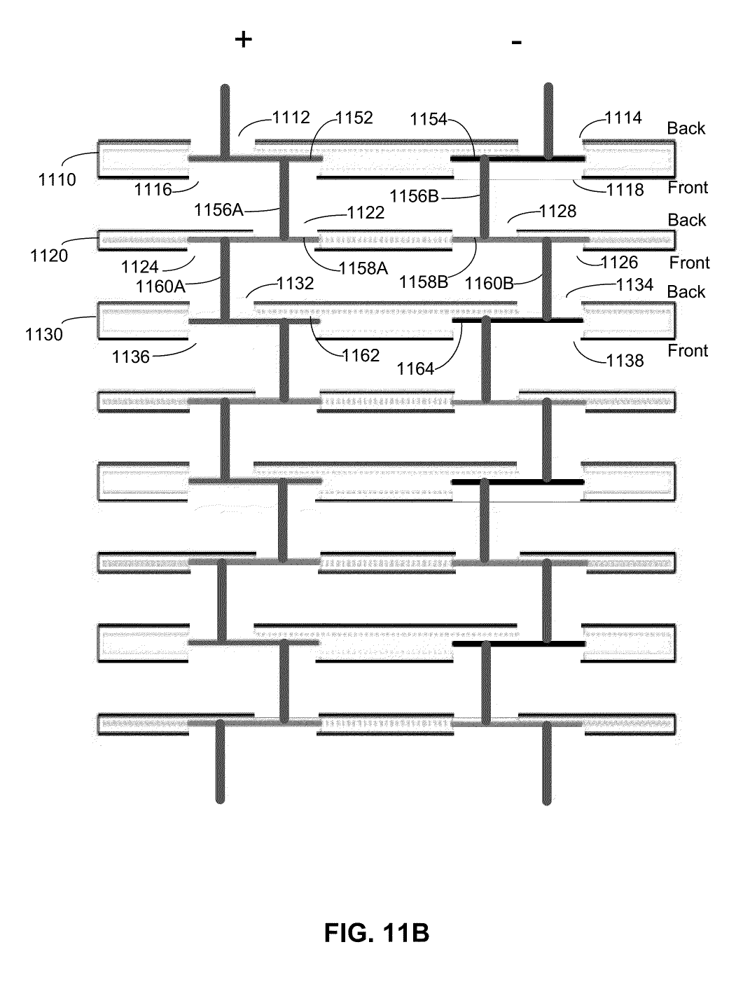

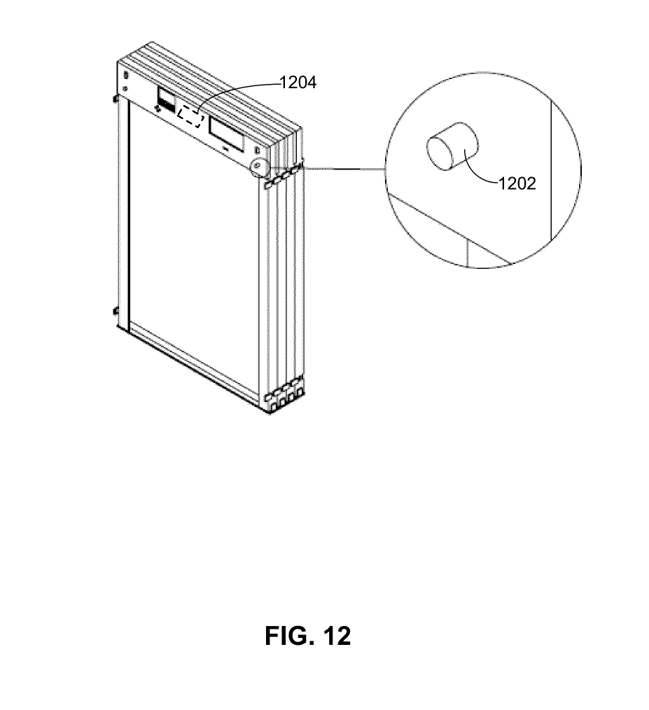

FIG. 3 is a schematic diagram of an exemplary battery holding device, in accordance with some disclosed embodiments. In FIG. 3, a battery holding device 300 is shown in both front and back views. Holding device 300 may include a side portion 302 and a receiving portion 306. Side portion 302 may include two pieces, each including a groove 304 for engaging the edges of a cell or battery, such as a pouch battery cell. For example, a pouch cell may be inserted into holding device 300 supported and/or guided by groove 304 into position. Receiving portion 306 may be a hollow structure with front face 308 and back face 310. One or more electrical terminals of a battery cell may be inserted into the receiving portion 306 and reside therein. When the electrical terminals are received by receiving portion 306, e.g., when the electrical terminals reside inside the hollow structure of receiving portion 306, front and back faces 308 and 310 may sandwich the electrical terminals between the front and back faces. For example, an intermediate position in which the battery cell slides into the holding device 300 is shown in FIGS. 10A and 11A, and a final position after the electrical terminals slide into receiving portion 306 is shown in FIG. 12. Front face 308 may include one or more front openings for exposing the electrical terminals from inside the receiving portion 306. For example, FIG. 3 shows two front openings 312 and 314, corresponding to positive and negative terminals, respectively. Similarly, back face 310 may include one or more back openings for exposing the electrical terminals from inside the receiving portion 306. For example, FIG. 3 shows two back openings 316 and 318, corresponding to negative and positive terminals, respectively.

Holding device 300 may include a foolproof structure to avoid mistakes in assembling multiple holding devices incorrectly. For example, FIG. 3 shows such a foolproof structure including a protruding structure 320 on the front face 308 and a hole 322 on the back face 310. Protruding structure 320 may have a size capable of engaging hole 322 such that when multiple holding devices are assembled together, protruding structure 320 of a first holding device may stick into hole 322 of a second holding device if they align in a correct direction, e.g., the front face of the first holding device attaches to the back face of the second holding device. If one intends to assemble them in a different way, e.g., attaching the front faces of both holding devices together, the protruding structures 320 on both front faces would prevent the two holding devices from engaging together.

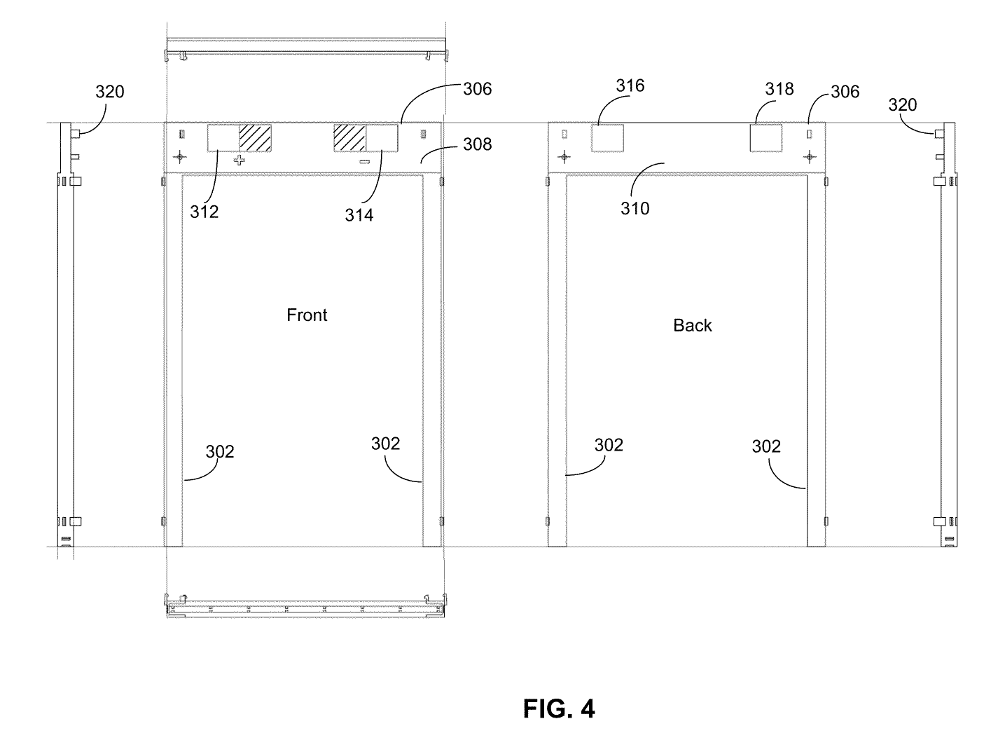

FIG. 4 is a plane view of the exemplary battery holding device shown in FIG. 3, in accordance with some disclosed embodiments. In FIG. 4, the size of front openings 312, 314 and back openings 316, 318 can be viewed more clearly than in FIG. 3. As seen in FIG. 4, the size of front openings 312, 314 may be larger than the size of back openings 316, 318. In some embodiments, the size of front openings 312, 314 may be about twice as large as that of back openings 316, 318. In operation, back opening 318 of a first battery holding device may be placed towards the left half of front opening 312 of an adjacent second battery holding device such that back opening 318 of the first battery holding device substantially overlays with the left half of front opening 312 of the second battery holding device. In FIG. 4, the left half of front opening 312 is clear while the right half is shadowed. This means that the left half can be seen through due to back opening 318 while the right half shows the inside wall of the back face panel. Similar configuration applies to front opening 314 and back opening 316. It is noted that the positions of front/back openings may be different from those shown in FIG. 4. For example, back openings 316 and 318 may be placed towards the center of back face 310. In another example, back opening 316 (or 318) may not overlay with front opening 312 (or 314).

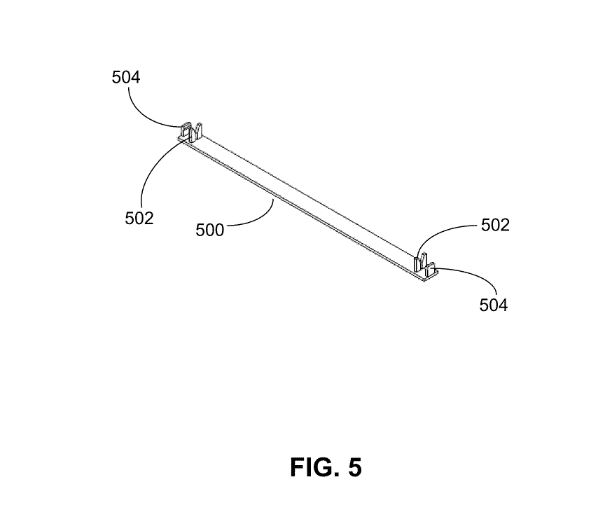

FIG. 5 is a schematic diagram of an exemplary bottom portion of a battery holding device, in accordance with some disclosed embodiments. In FIG. 5, bottom portion 500 may include base ribs 502 for holding a bottom edge of a battery cell. Bottom portion 500 may also include clips 504 for engaging side portion 302 to form a closed frame to enclose the battery cell.

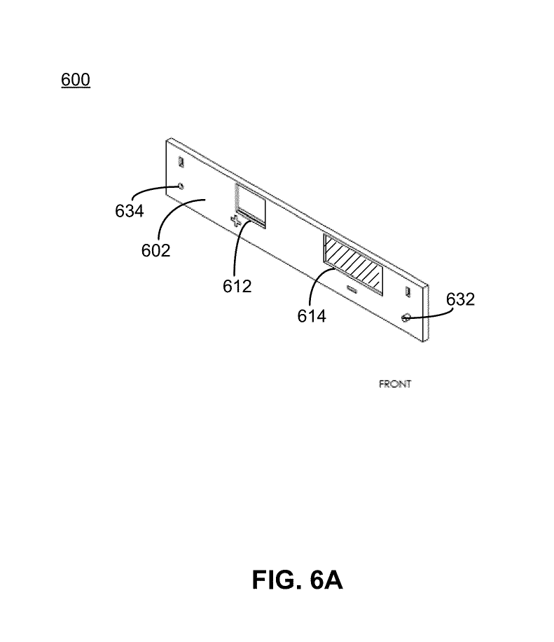

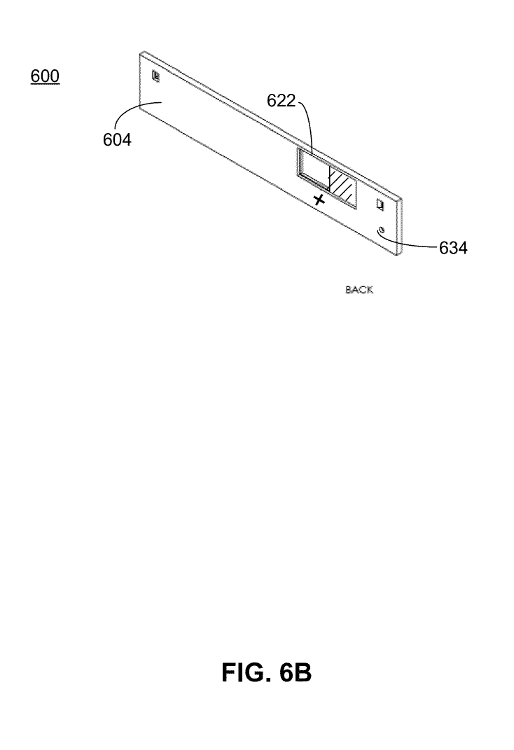

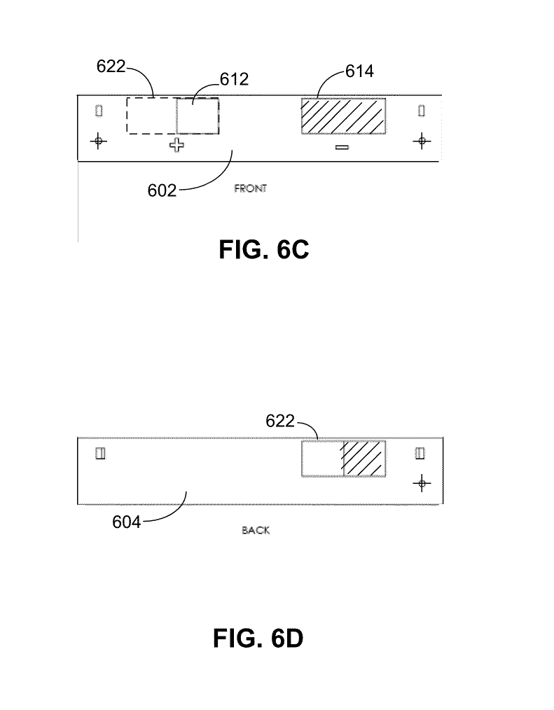

FIG. 6A shows an exemplary interconnect device for a serial connection configuration, in accordance with some disclosed embodiments. In FIG. 6A, interconnect device 600 may include an inner-hollow structure including a front surface 602 and a back surface 604 (shown in FIG. 6B). Strip connectors may be placed inside interconnect device 600 to provide the serial connection configuration of two or more battery cells, as will be explained in greater detail below. Front surface 602 may include one or more front apertures. For example, FIG. 6A shows front apertures 612 and 614, corresponding to the positive and negative terminals, respectively.

FIG. 6B shows the back surface of the interconnect device 600 shown in FIG. 6A. Back surface 604 may include one or more back apertures. For example, FIG. 6B shows a back aperture 622, corresponding to the positive terminal.

Interconnect device 600 may include a foolproof structure similar to that of holding device 300. For example, FIG. 6A shows a foolproof structure comprising a protruding structure 632 on front surface 602 and a through hole 634. Similarly, FIG. 6B shows the through hole 634 on back surface 604. The features of protruding structure 632 are similar to those of protruding structure 320 and the features of hole 634 are similar to those of hole 322. Therefore, a detailed description of protruding structure 632 and hole 634 is omitted.

FIG. 6C is a plane view of the front surface 602 of the exemplary interconnect device 600 shown in FIG. 6A; and FIG. 6D is a plane view of the back surface 604 of the interconnect device 600, in accordance with some disclosed embodiments. FIG. 6C shows positive front aperture 612 and negative front aperture 614. In FIG. 6C, the position of positive back aperture 622 is shown in dashed lines. In some embodiments, positive back aperture 622 may at least partially overlay with positive front aperture 612, as shown in FIG. 6C. In other embodiments, positive back aperture 622 may not overlay with positive front aperture 612. Rather, the positions of these two apertures (or the projections of these two apertures) may be located on different parts such that no through hole is formed. FIG. 6D shows positive back aperture 622. The left part of back aperture 622 is without shadow, indicating that part is a through opening because of the overlapping with positive front aperture 612. The shadowed part of back aperture 622 indicates the inner side of front face 602. As indicated above, positive back opening 622 may be placed in a different location on back surface 604 such that positive back opening 622 may entirely overlap, partially overlap, or not overlap at all, with positive front opening 612. In some embodiments, the front and back openings may be placed such that when connecting two cells, one terminal of a first cell is electrically isolated from another terminal of a second cell.

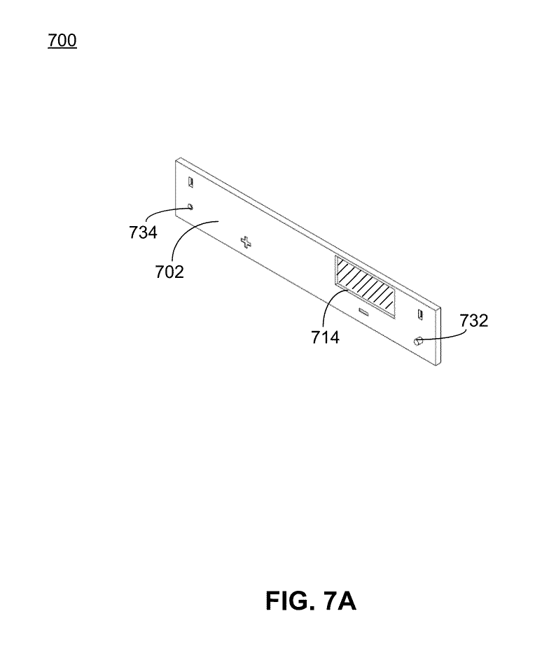

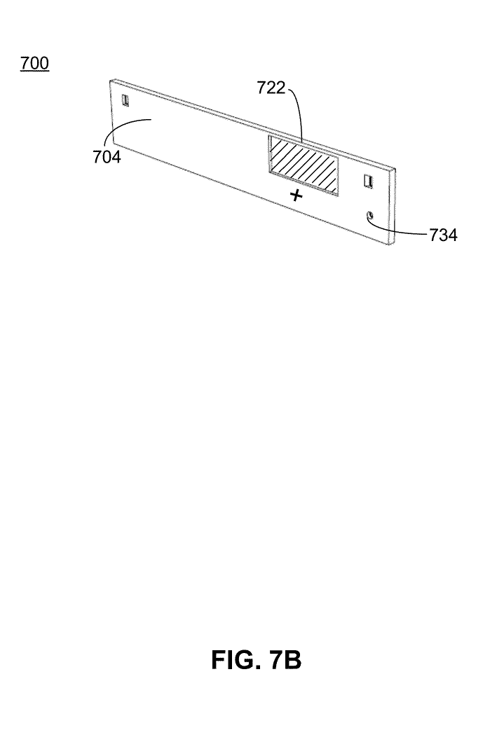

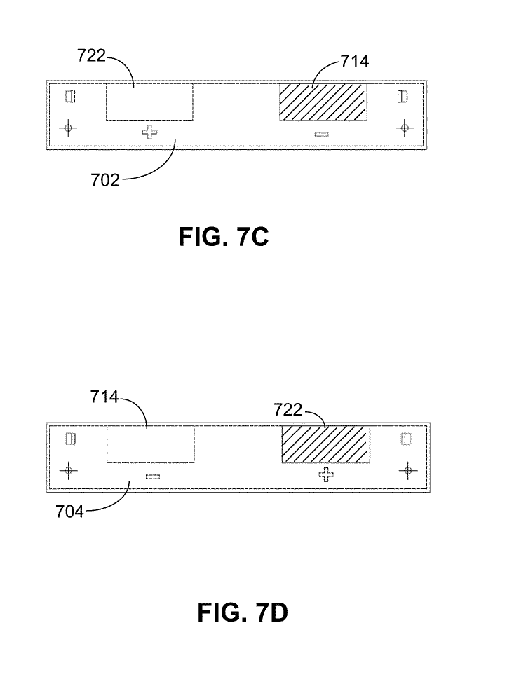

FIG. 7A shows another exemplary interconnect device for serial connection configuration, in accordance with some disclosed embodiments. In FIG. 7A, interconnect device 700 may include an inner-hollow structure including a front surface 702 and a back surface 704 (shown in FIG. 7B). Strip connectors may be placed inside interconnect device 700 to provide serial connection configuration of two or more battery cells, as will be explained in greater detail below. Front surface 702 may include one or more front apertures. For example, FIG. 7A shows a front aperture 714, corresponding to the negative terminal.

FIG. 7B shows the back surface of the interconnect device 700 shown in FIG. 7A. Back surface 704 may include one or more back apertures. For example, FIG. 7B shows a back aperture 722, corresponding to the positive terminal.

Similar to interconnect device 600, interconnect device 700 may include a foolproof structure. For example, FIG. 7A shows a foolproof structure comprising a protruding structure 732 on front surface 702 and a through hole 734. Similarly, FIG. 7B shows the through hole 734 on back surface 704. The features of protruding structure 732 are similar to those of protruding structure 320 and the features of hole 734 are similar to those of hole 322. Therefore, a detailed description of protruding structure 732 and hole 734 is omitted.

FIG. 7C is a plane view of the front surface 702 of the exemplary interconnect device 700 shown in FIG. 7A; and FIG. 7D is a plane view of the back surface 704 of the interconnect device 700, in accordance with some disclosed embodiments. FIG. 7C shows negative front aperture 714 in solid lines. In FIG. 7C, the position of positive back aperture 722 is shown in dashed lines. Similarly, FIG. 7D shows positive back aperture 722 in solid lines and the position of negative front aperture 714 is shown in dashed lines.

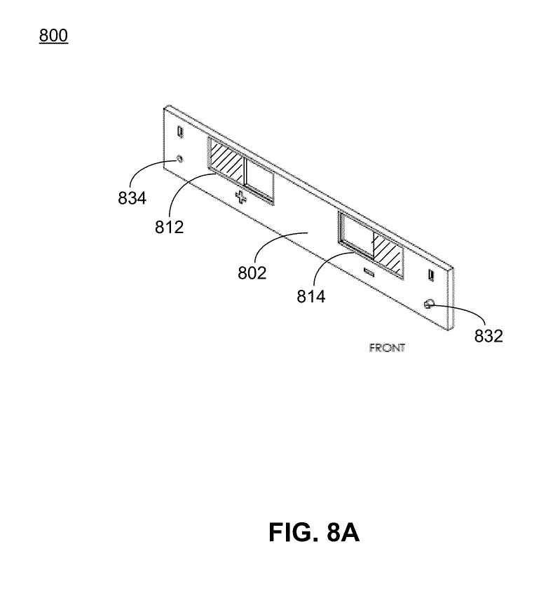

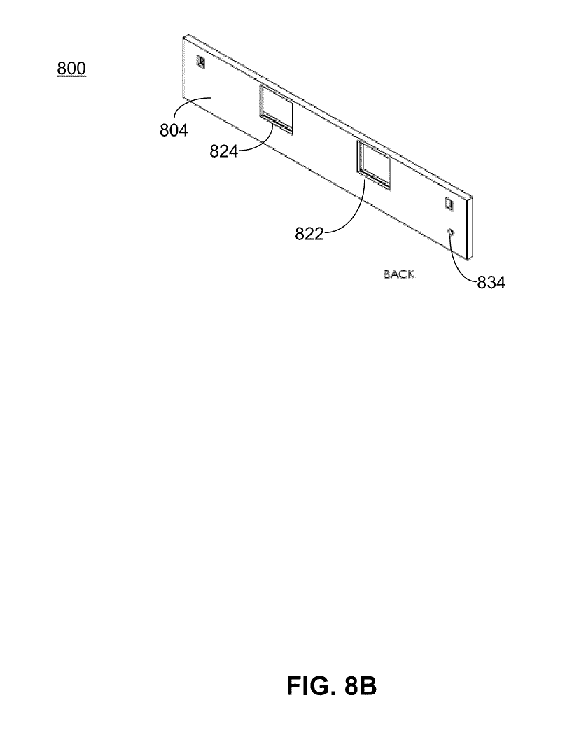

FIG. 8A shows an exemplary interconnect device for parallel connection configuration, in accordance with some disclosed embodiments. In FIG. 8A, interconnect device 800 may include an inner-hollow structure including a front surface 802 and a back surface 804 (shown in FIG. 8B). Strip connectors may be placed inside interconnect device 800 to provide a parallel connection configuration of two or more battery cells, as will be explained in greater detail below. Front surface 802 may include one or more front apertures. For example, FIG. 8A shows two front apertures 812 and 814, corresponding to positive and negative terminals, respectively.

FIG. 8B shows the back surface of the interconnect device 800 shown in FIG. 8A. Back surface 804 may include one or more back apertures. For example, FIG. 8B shows two back apertures 822 and 824, corresponding to positive and negative terminals, respectively.

Interconnect device 800 may include a foolproof structure similar to that of holding device 300. For example, FIG. 8A shows a foolproof structure comprising a protruding structure 832 on front surface 802 and a hole 834. Similarly, FIG. 8B shows the through hole 834 on back surface 804.

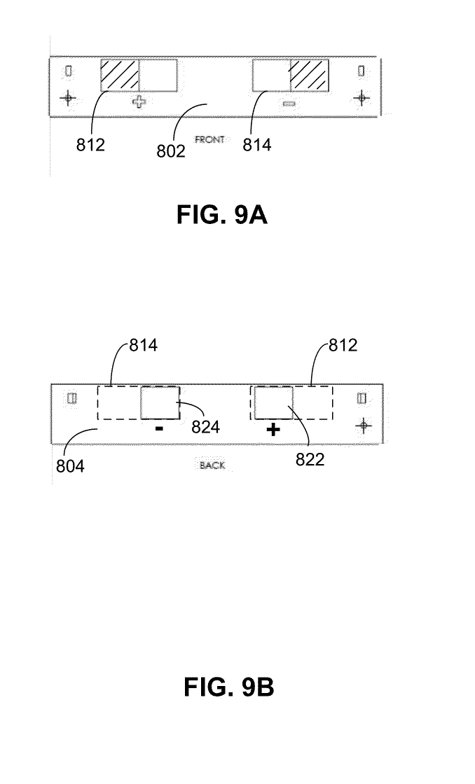

FIG. 9A is a plane view of the front surface 802 of the exemplary interconnect device 800 shown in FIG. 8A; and FIG. 9B is a plane view of the back surface 804 of the interconnect device 800, in accordance with some disclosed embodiments. FIG. 9A shows positive front aperture 812 and negative front aperture 814. FIG. 9B shows positive back aperture 822 and negative back aperture 824. In FIG. 9B, the position of positive front aperture 812 and the position of negative front aperture 814 are shown in dashed lines. It is noted that in FIGS. 9A and 9B, the size of positive front aperture 812 is larger than that of positive back aperture 822, and the size of negative front aperture 814 is larger than that of negative back aperture 824. In some embodiments, positive front aperture 812 may be about twice as large as positive back aperture 822. In some embodiments, negative front aperture 814 may be about twice as large as negative back aperture 824. In FIG. 9B, positive back aperture 822 may overlay with positive front aperture 812 and is positioned towards the right half of positive front aperture 812 (as seen in FIG. 9A); negative back aperture 824 overlays with negative front aperture 814 and is positioned towards the left half of negative front aperture 814 (as seen in FIG. 9A). As a result, the right half of positive front aperture 812 and the left half of negative front aperture 814 can be seen through (clear) while the left half of positive front aperture 812 and the right half of negative front aperture 814 show the inside wall of back surface panel (shadowed). It is noted that in some embodiments, the relative positions of front and back apertures may be changed depending on particular applications. For example, positive front aperture 812 may entirely overlap, partially overlap, or not overlap at all, with positive back aperture 822.

FIG. 10A shows an exemplary battery package configuration using serial connection, in accordance with some disclosed embodiments. In FIG. 10A, four batteries or cells 1006 are to be assembled into a battery package. Each battery is held by a battery holding device (e.g., 1010, 1030, etc.). Each battery holding device has a side portion 1002. Side portion 1002 has a groove 1004 for engaging an edge of battery 1006. For example, battery 1006 may be inserted into holding device 1010 along groove 1004. Bottom portion 1008 may engage side portion 1002 to enclose battery 1006 when battery 1006 is inserted correctly into holding device 1010. Battery 1006 may include two terminals 1052 and 1054. For illustration purpose, it is assumed that terminal 1052 is a positive terminal and terminal 1054 is a negative terminal. Holding device 1010 may include a receiving portion 1011. Receiving portion 1011 may receive terminals 1052 and 1054 when battery 1006 is inserted into holding device 1010. Receiving portion 1011 may include a front face, indicated by “Front,” and a back face, indicated by “Back” in FIG. 10A. Front face may include front openings, such as openings 1016 and 1018. Back face may include back openings, such as openings 1012 and 1014. When battery 1006 is inserted into holding device 1010, positive terminal 1052 may be exposed through opening 1016 on the front face and through opening 1012 on the back face. Similarly, negative terminal 1054 may be exposed through opening 1018 on the front face and through opening 1014 on the back face.

An interconnect device (e.g, 1020, 1080, etc.) may be interlaced between two adjacent battery holding devices. Interconnect devices 1020, 1080, etc. are the same as interconnect device 600 shown in FIGS. 6A-6D. The battery package shown in FIG. 10A is in a serial connection configuration.

FIG. 10B is a schematic diagram illustrating the exemplary serial connection configuration shown in FIG. 10A, in accordance with some disclosed embodiments. In FIG. 10B, only the components of the top three devices are numbered to show the serial connection configuration. The rest of the devices operate in a similar manner and therefore numerals are omitted. Referring to FIG. 10B, openings exposing positive terminals (e.g., terminals 1052, 1062) are placed to the left side and openings exposing negative terminals (e.g., terminals 1054, 1064) are placed to the right side. In addition, for each holding device (e.g., 1010, 1030) and each interconnect device (e.g., 1020), the top face/surface in FIG. 10B is the back face/surface in FIGS. 6B and 7B; the bottom face/surface in FIG. 10B is the front face/surface in FIGS. 6A and 7A.

The first holding device 1010 holds the first battery. The positive terminal 1052 and the negative terminal 1054 of the first battery are received in the receiving portion of the first holding device 1010. Positive front opening 1016 and negative front opening 1018 are on the front face; positive back opening 1012 and negative back opening 1014 are on the back face. Similarly, the second holding device 1030 holds the second battery. The positive terminal 1062 and the negative terminal 1064 of the second battery are received in the receiving portion of the second holding device 1030. Positive front opening 1036 and negative front opening 1038 are on the front face; positive back opening 1032 and negative back opening 1034 are on the back face.

Interconnect device 1020 has front apertures 1024 and 1026 on the front surface, and a back aperture 1022 on the back surface. Connector 1058 (e.g., a strip connector) resides inside interconnect device 1020 and is sandwiched between the front and back surfaces. Reference number 1056 indicates that the positive terminal 1052 and connector 1058 are connected through positive front opening 1016 and back aperture 1022, by, e.g., spot welding. Reference number 1060 indicates connector 1058 and negative terminal 1064 are connected through negative back opening 1034 and negative front aperture 1026, by, e.g., spot welding. In this way, positive terminal 1052 of the first battery is connected with negative terminal 1064 of the second battery, thereby establishing a serial connection between the first and second batteries. As noted above, reference numbers 1056 and 1060 indicate connections, that may be implemented by welding (e.g., spot welding, laser welding, etc.) the terminals and the connectors together or other means, such as wiring, etc.

FIG. 10C shows another exemplary battery package configuration using a serial connection. FIG. 10C is similar to FIG. 10A. The difference between FIG. 10C and FIG. 10A is that interconnect devices 1020, 1080, etc. used in FIG. 10A are replaced by interconnect devices 1020A, 1080A, etc. Interconnect devices 1020A, 1080A, etc. are similar to interconnect device 700 shown in FIGS. 7A-7D.

FIG. 10D is a schematic diagram illustrating the exemplary serial connection configuration shown in FIG. 10C. FIG. 10D is similar to FIG. 10B. The difference between FIG. 10D and FIG. 10B is that interconnect devices 1020, 1080, etc. used in FIG. 10B are replaced by interconnect devices 1020A, 1080A, etc. Interconnect device 1020A includes a front aperture 1026 and a back aperture 1022, but does not include front aperture 1024 as shown in FIG. 10B. The connection manner is similar to that shown in FIG. 10B and therefore a detailed description is omitted.

FIG. 11A is an exemplary battery package configuration using a parallel connection, in accordance with some disclosed embodiments. In FIG. 11A, four batteries or cells 1106 are to be assembled into a battery package. Each battery is held by a battery holding device (e.g., 1110, 1130, etc.). Each battery holding device has a side portion 1102. Side portion 1102 has a groove 1104 for engaging an edge of battery 1106. For example, battery 1106 may be inserted into holding device 1110 along groove 1104. Bottom portion 1108 may engage side portion 1102 to enclose battery 1106 when battery 1106 is inserted into holding device 1110. Battery 1106 may include two terminals 1152 and 1154. For illustration purpose, it is assumed that terminal 1152 is a positive terminal and terminal 1154 is a negative terminal. Holding device 1110 may include a receiving portion 1111. Receiving portion 1111 may receive terminals 1152 and 1154 when battery 1106 is inserted into holding device 1110. Receiving portion 1111 may include a front face, indicated by “Front,” and a back face, indicated by “Back” in FIG. 11A. Front face may include front openings, such as openings 1116 and 1118. Back face may include back openings, such as openings 1112 and 1114. When battery 1106 slides into holding device 1110, positive terminal 1152 may be exposed through opening 1116 on the front face and through opening 1112 on the back face. Similarly, negative terminal 1154 may be exposed through opening 1118 on the front face and through opening 1114 on the back face.

An interconnect device (e.g., 1120, 1180, etc.) is interlaced between two adjacent battery holding devices. Interconnect devices 1120, 1180, etc. are the same as interconnect device 800 shown in FIGS. 8A-8B. The battery package shown in FIG. 11A is in a parallel connection configuration.

FIG. 11B is a schematic diagram illustrating the exemplary parallel connection configuration shown in FIG. 11A, in accordance with some disclosed embodiments. In FIG. 11B, only the components of the top three devices are numbered to show the parallel connection configuration. The rest of the devices operate in a similar manner and therefore numerals are omitted. Referring to FIG. 11B, openings exposing positive terminals (e.g., terminals 1152, 1162) are placed to the left side and openings exposing negative terminals (e.g., terminals 1154, 1164) are placed to the right side. In addition, for each holding device (e.g., 1110, 1130) and each interconnect device (e.g., 1120), the top face/surface in FIG. 11B is the back face/surface in FIGS. 8B and 9B; the bottom face/surface in FIG. 11B is the front face/surface in FIGS. 8A and 9A.

The first holding device 1110 holds the first battery. The positive terminal 1152 and the negative terminal 1154 of the first battery are received in the receiving portion of the first holding device 1110 and are sandwiched between the front and back faces of the first holding device 1110. Positive front opening 1116 and negative front opening 1118 are on the front face; positive back opening 1112 and negative back opening 1114 are on the back face. Similarly, the second holding device 1130 holds the second battery, the positive terminal 1162 and the negative terminal 1164 of which resides in the receiving portion of the second holding device 1130 and are sandwiched by the front and back faces of the second holding device 1130. Positive front opening 1136 and negative front opening 1138 are on the front face; positive back opening 1132 and negative back opening 1134 are on the back face.

Interconnect device 1120 has a positive front aperture 1124 and a negative front aperture 1126 on the front surface, and a positive back aperture 1122 and a negative back aperture 1128 on the back surface. Connectors 1158A and 1158B (e.g., strip connectors) reside inside interconnect device 1120 and are sandwiched between the front and back surfaces. Connectors 1158A and 1158B are electrically insulated from each other. Reference number 1156A indicates a connection between the positive terminal 1152 and connector 1158A through positive front opening 1116 and positive back aperture 1122; reference number 1156B indicates a connection between the negative terminal 1154 and connector 1158B through negative front opening 1118 and negative back aperture 1128. Similarly, reference number 1160A indicates a connection between connector 1158A and positive terminal 1162 through positive back opening 1132 and positive front aperture 1124; reference number 1160B indicates a connection between connector 1158B and negative terminal 1164 through negative back opening 1134 and negative front aperture 1126. In this way, positive terminal 1152 of the first battery is connected with positive terminal 1162 of the second battery, and negative terminal 1154 of the first battery is connected with negative terminal 1164 of the second battery, thereby establishing a parallel connection between the first and second batteries. As noted above, connections 1156A, 1156B, 1160A, and 1060B may be implemented by welding (e.g., spot welding, laser welding, etc.) or wiring terminal 1152 and connector 1158A together (or similarly terminal 1154 and connector 1158B, terminal 1162 and connector 1158A, and between terminal 1164 and connector 1158B).

FIG. 12 is a schematic diagram of an exemplary battery package having multiple batteries with multiple holding devices assembled together. The holding device each includes a foolproof structure, in accordance with some disclosed embodiments. In FIG. 12, protruding structure 1202 of the foolproof structure is shown to engage with corresponding holes when multiple holding devices are assembled together. The foolproof structure may function in a similar manner when holding devices and interconnect devices are interlaced.

In some embodiments, a battery holding device may include one or more integrated circuits (ICs), such as IC 1204, connected to the terminals of the battery. IC 1204 may monitor status of one or more batteries, control or manage the batteries, provide communication channels between the batteries and a control center, or any other suitable functions. Battery monitor and control circuits are described in U.S. patent application Ser. No. 13/896,985, titled Smart Battery System, filed on May 17, 2013, which is incorporated herewith by reference.

For example, IC 1204 may include one or more of the following sensors: a current sensor, a voltage sensor, an accelerometer, a thermocoupler, a hygrometer, a GPS, a gas sensor, an impedance sensor, a strain sensor, a pressure sensor, and a dimensional sensor. The list of sensors is not an exhaustive list, and additional sensors may be included. These sensors can be sensors available on the market as described in U.S. patent application Ser. No. 13/896,985.

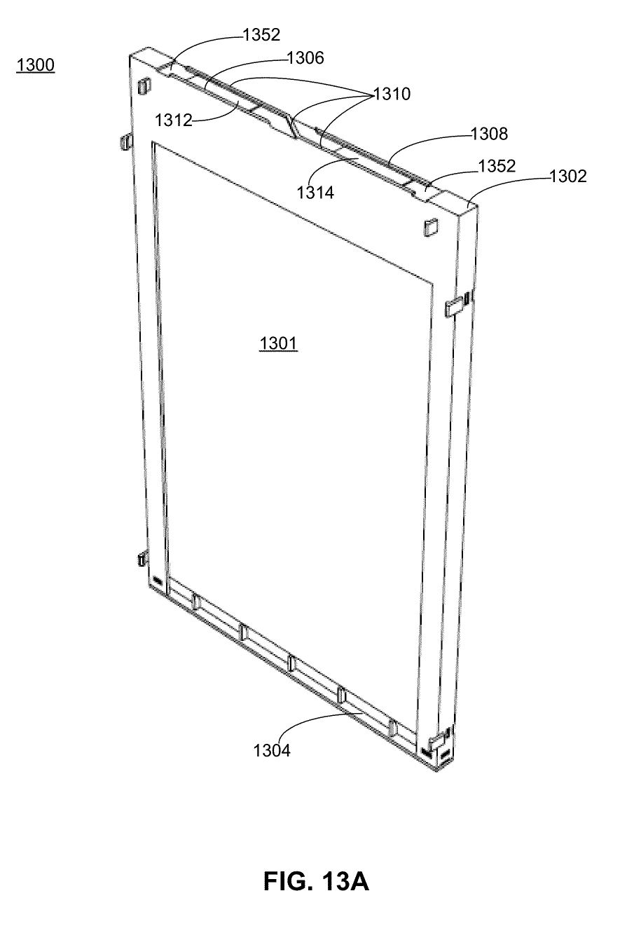

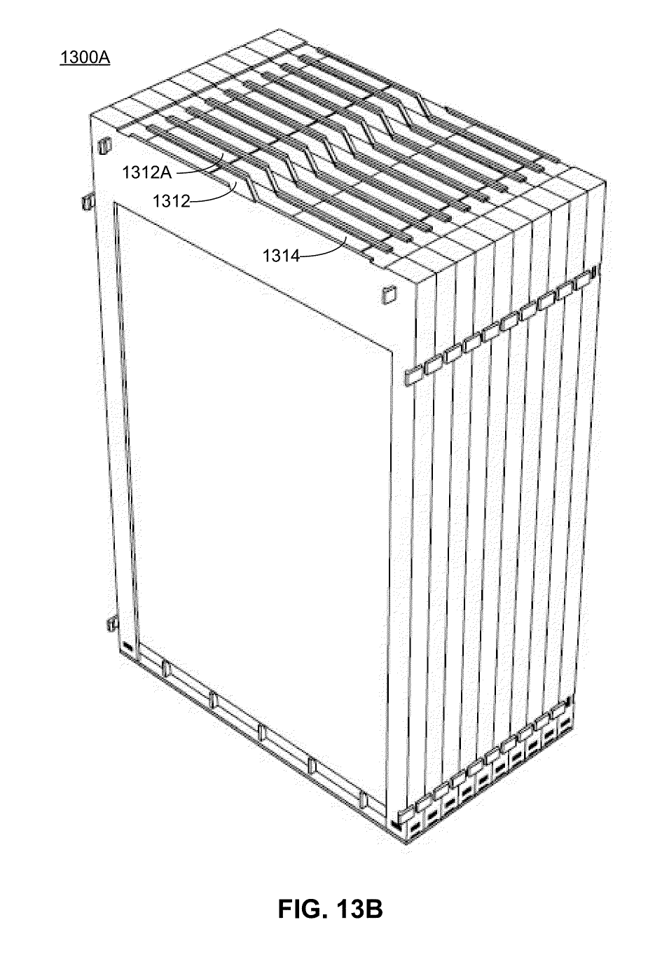

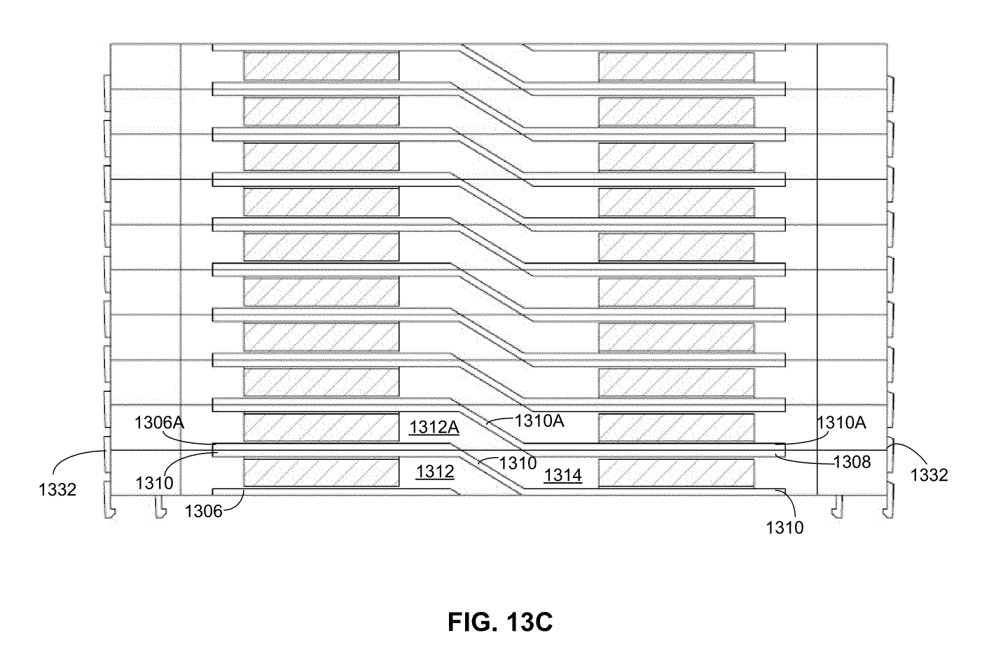

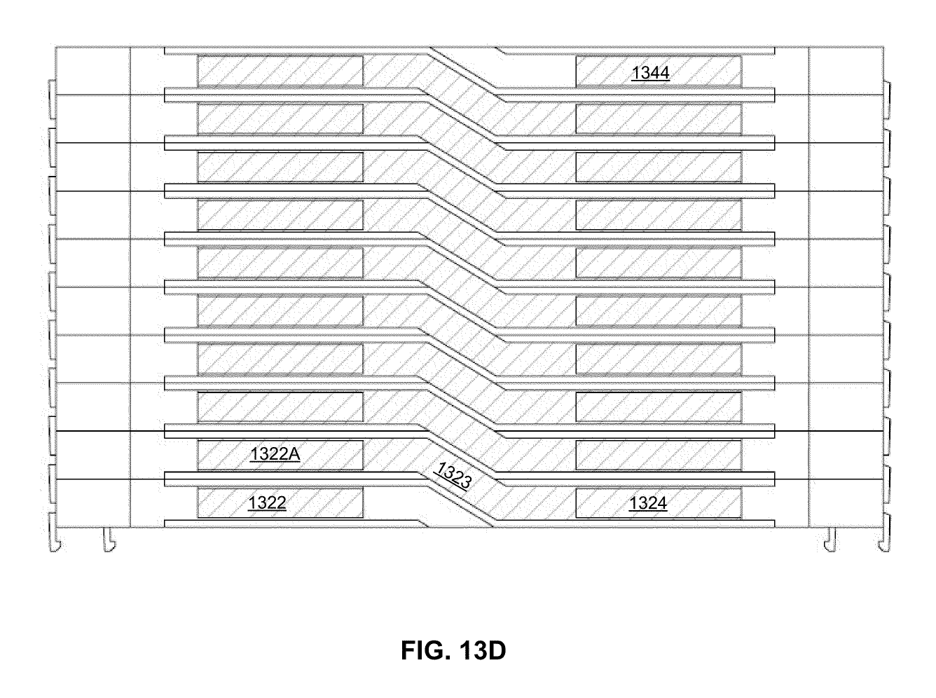

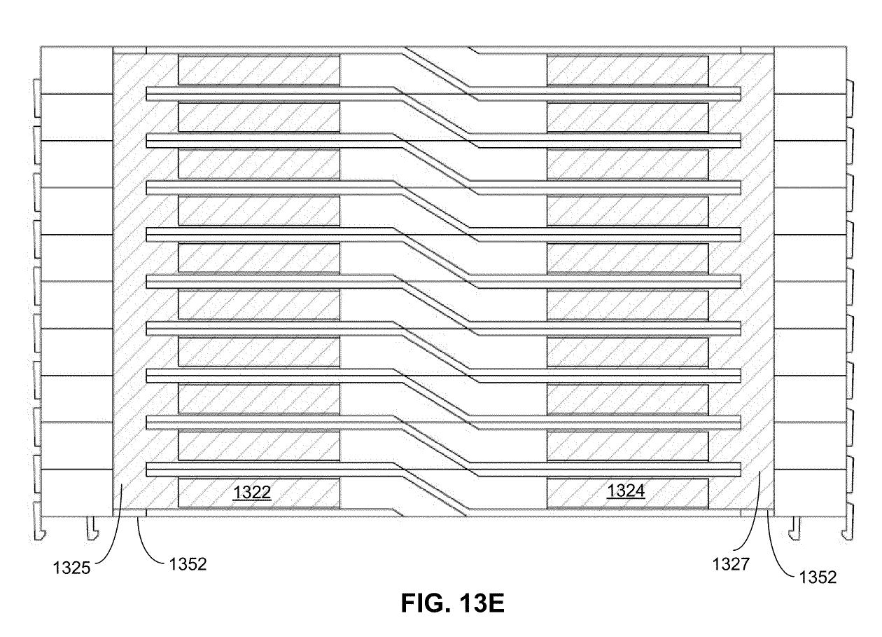

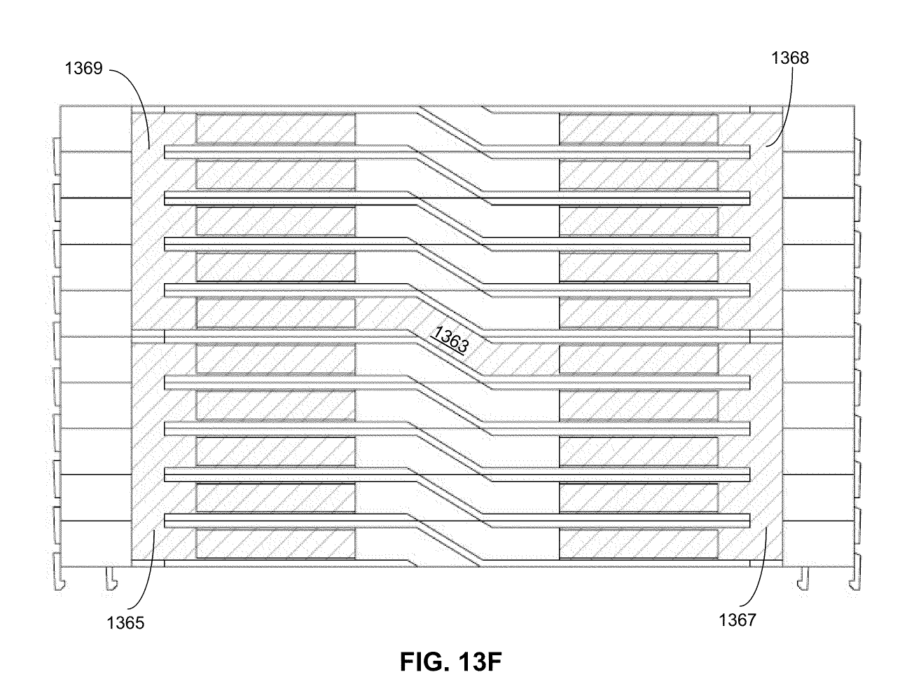

FIG. 13A is a schematic diagram of an exemplary battery package 1300 having a single battery cell, in accordance with some disclosed embodiments. In FIG. 13A, battery package 1300 includes a battery holding device 1302, a bottom portion 1304, and a battery cell 1301. Battery cell 1301 is enclosed by battery holding device 1302 and bottom portion 1304 in a similar manner to that shown in FIG. 10A. The difference between battery package 1300 and battery package shown in FIG. 10A is that the connection portion (e.g., portion for making serial/parallel connections) is on the top part of battery holding device 1302, rather than on the front/back surfaces as shown in FIG. 10A. Referring to FIG. 13A, battery holding device 1302 includes on its top a first edge 1306, a second edge 1308, and a third edge 1310. The first edge 1306 is located on the front side (towards the reader) of battery holding device 1302, rising upward. Similarly, the second edge 1308 is located on the back side (away from the reader) of battery holding device 1302, rising upward. The third edge 1310, also rising upward, begins from the back side, extends along the back side, then crosses the top surface and reaches the front side, extends along the front side, and finally ends on the front side. The first and third edges 1306 and 1310, together with part of the top surface of battery holding device 1302, form a first channel 1312. Similarly, the second and third edges 1308 and 1310, together with part of the top surface of battery holding device 1302, form a second channel 1314. Channels 1312 and 1314 may host connectors connecting to positive and negative terminals of battery 1301, respectively. Channels 1312 and 1314 may be electrically isolated from each other because of the center portion of edge 1310. Battery holding device 1302 may also include cutouts 1352 located between the edges and the left/right boundary. Battery holding device 1302 may include one or more apertures on the top to allow battery terminals to extend out.

FIG. 13B is a schematic diagram of an exemplary battery package 1300A having multiple battery cells. In FIG. 13B, 10 battery holding devices similar to that shown in FIG. 13A are assembled together to form a multi-cell battery package. Referring to FIG. 13B, when two or more battery holding devices are assembled together, the edges on the top portion of each battery holding device may form certain patterns that facilitate interconnection among battery cells. For example, the opening of channel 1314 of the first battery holding device may communicate with the opening of channel 1312A of the second battery holding device such that channels 1314 and 1312A form a continuous channel. The continuous channel can be seen more clearly in FIG. 13C, which shows the top view of the multi-cell battery package 1300A. In FIG. 13C, edge 1310 of the first battery holding device attaches to edge 1306A of the second battery holding device by, for example, coupling device 1332. The length of edge 1306A may be set to be substantially the same as the upper portion of edge 1310. Similarly, edge 1308 of the first battery holding device may be attached to edge 1310A of the second battery holding device. Channel 1314 on top of the first battery holding device may connect to channel 1312A on top of the second battery holding device and form a continuous channel.

FIG. 13D shows the top view of multi-cell battery package 1300A after the 10 cells are connected together in series. In FIG. 13D, a connector 1323 extends along the continuous channel formed by channels 1312A and 1314 (FIG. 13C) and connect terminal 1324 of the first cell with terminal 1322A of the second cell. In some embodiments, terminals 1324 and 1322A may have opposite polarities (e.g., 1324 is positive and 1322A is negative, or 1324 is negative and 1324 is positive). Accordingly, the first and second battery cells can be connected in series. In FIG. 13D, all 10 battery cells can be connected together in series in a similar manner. The assembled battery package may use terminals 1322 and 1344 as the package terminals.

Connector 1323 may include a conductive bus bar, a metal sheet, a PCBA, a flex PCB, etc. When PCB is used as connector, terminals 1322A and 1324 may be connected to substrate, ports, connecting points, etc., of the PCB. The PCB connector may also include integrated circuits, microchips, controllers, etc., to control, monitor, and/or regulate the battery cells. Connector 1323 may be fixed to the continuous channel by welding, screws, snap fit, or magnets to the cells.

FIG. 13E shows the top view of multi-cell battery package 1300A after the 10 cells are connected together in parallel. In FIG. 13E, connector 1325 is used to connect all positive (or negative) terminals together through, for example, cutouts 1352. For example, the vertical portion of connector 1325 may extend through multiple battery holding devices along a channel formed by cutouts 1325 of these battery holding devices. The horizontal portions of connector 1325 may be used to connect to the terminals of the cells. Similarly, connector 1327 is used to connect all negative (or positive) terminals together. Other than the shape, connectors 1325 and 1327 may be similar to connector 1323.

FIG. 13F shows the top view of multi-cell battery package 1300A after the 10 cells are connected together in serial-parallel configuration. In FIG. 13F, the upper five battery cells are connected together in parallel using connectors 1369 and 1368, and the lower five battery cells are also connected together in parallel using connectors 1365 and 1367. Then, the upper and lower cells are connected together in series using connector 1363. A person of ordinary skills in the art would appreciate that other variations of the serial-parallel configurations are obvious using the techniques disclosed with respect to FIGS. 13A-13F.

In the foregoing description of exemplary embodiments, various features are grouped together in a single embodiment for purposes of streamlining the disclosure. This method of disclosure is not to be interpreted as reflecting an intention that the claims require more features than are expressly recited in each claim. Rather, as the following claims reflect, inventive aspects lie in less than all features of a single foregoing disclosed embodiment. Thus, the following claims are hereby incorporated into this description of the exemplary embodiments, with each claim standing on its own as a separate embodiment of the invention.

Moreover, it will be apparent to those skilled in the art from consideration of the specification and practice of the present disclosure that various modifications and variations can be made to the disclosed systems and methods without departing from the scope of the disclosure, as claimed. Thus, it is intended that the specification and examples be considered as exemplary only, with a true scope of the present disclosure being indicated by the following claims and their equivalents.

1. A device for holding a battery, comprising:
a receiving portion for receiving electrical terminals of the battery, wherein the receiving portion includes a front face and a back face,
wherein the front face includes at least one front opening for exposing at least one of the electrical terminals; and
wherein the back face includes at least one back opening for exposing at least one of the electrical terminals.

2. The device of claim 1, further comprising a side portion, wherein the side portion includes a groove for engaging an edge of the battery.

3. The device of claim 1, wherein the front face includes a front opening corresponding to a positive terminal or a negative terminal of the battery, and the back face includes a back opening corresponding to the negative terminal or the positive terminal of the battery.

4. The device of claim 1, wherein a size of the at least one front opening is different from a size of the at least one back opening.

5. The device of claim 1, further comprising a protruding structure on the front face and a hole on the back face, wherein the protruding structure has a size capable of engaging the hole.

6. The device of claim 2, further comprising a bottom portion to enclose the battery when engaging the side portion.

7. The device of claim 1, further comprising an interconnect portion for interconnecting two or more batteries, the interconnect portion including a front surface and a back surface, wherein:
the front surface includes at least one front aperture; and
the back surface includes at least one back aperture.

8. The device of claim 7, wherein:
the front surface includes a front aperture; and
the back surface includes a back aperture,
wherein the front and back apertures are positioned such that one terminal of a first battery is isolated from another terminal of a second battery.

9. The device of claim 7, wherein:
the front surface includes a positive front aperture and a negative front aperture; and
the back surface includes a positive back aperture and a negative back aperture.

10. The device of claim 7, wherein the interconnect portion includes a protruding structure on the front surface and a hole on the back surface, wherein the protruding structure has a size capable of engaging the hole.

11. A battery package, comprising:
a plurality of batteries; and
a plurality of holding devices for holding the plurality of batteries, each of the plurality of holding devices comprising:
a receiving portion for receiving electrical terminals of one of the plurality of batteries, wherein the receiving portion includes a front face and a back face,
wherein the front face includes at least one front opening for exposing one of the electrical terminals of the one of the plurality of batteries; and
wherein the back face includes at least one back opening for exposing one of the electrical terminals of the one of the plurality of batteries.

12. The battery package of claim 11, wherein the plurality of batteries include a prismatic cell or a pouch cell.

13. The battery package of claim 11, wherein the plurality of batteries include a Li-Ion cell or a Li-polymer cell.

14. The battery package of claim 11, further comprising one or more interconnect devices, each of the one or more interconnect devices being interlaced between two adjacent holding devices, each of the one or more interconnect devices comprising a front surface and a back surface, wherein:
the front surface includes at least one front aperture; and
the back surface includes at least one back aperture.

15. The battery package of claim 14, wherein:
the front surface includes a front aperture; and
the back surface includes a back aperture,
wherein the front and back apertures are positioned such that one terminal of a first battery is isolated from another terminal of a second battery.

16. The battery package of claim 15, further comprising a connector residing in a first interconnect device, wherein the connector connects a first positive electrical terminal of the first battery residing in a first holding device immediately in front of the first interconnect device and a second negative electrical terminal of the second battery residing in a second holding device immediately behind the first interconnect device, wherein:
the first positive electrical terminal of the first battery connects with the connector through a back opening on the back face of the first holding device and the front aperture of the first interconnect device; and
the second negative electrical terminal of the second battery connects with the connector through a front opening on the front face of the second holding device and the back aperture of the first interconnect device.

17. The battery package of claim 16, wherein:
the front surface includes a positive front aperture and a negative front aperture; and
the back surface includes a positive back aperture and a negative back aperture.

18. The battery package of claim 17, further comprising first and second connectors residing in a first interconnect device, wherein:
the first connector connects a positive electrical terminal of a first battery residing in a first holding device immediately in front of the first interconnect device and a positive electrical terminal of a second battery residing in a second holding device immediately behind the first interconnect device; and
the second connector connects a negative electrical terminal of the first battery and a negative electrical terminal of the second battery;
wherein:
the positive electrical terminal of the first battery connects with the first connector through a first back opening on the back face of the first holding device and the positive front aperture of the first interconnect device;
the positive electrical terminal of the second battery connects with the first connector through a first front opening on the front face of the second holding device and the positive back aperture of the first interconnect device;
the negative electrical terminal of the first battery connects with the second connector through a second back opening on the back face of the first holding device and the negative front aperture of the first interconnect device; and
the negative electrical terminal of the second battery connects with the second connector through a second front opening on the front face of the second holding device and the negative back aperture of the first interconnect device.

19. A device for holding a battery, comprising:
a receiving portion for receiving electrical terminals of the battery, wherein the receiving portion includes:
first and second edges extending along first and second sides of the receiving portion, respectively; and
a third edge extending from the first side to the second side of the receiving portion, the first and third edges forming a first channel and the second and third edges forming a second channel;
wherein the first and second channels are electrically isolated from each other.

20. A battery pack including at least two of the devices according to claim 19 aligned together, wherein a first channel of one of the devices and a second channel of an adjacent device form a continuous channel.
